(19) United States
(12) Patent Application Publication
(10) Pub. No.: US 2023/0347431 A1
(43) Pub. Date: Nov. 2, 2023

(54) NON-ELECTROLYTIC DEPOSITION OF ELECTRODE FOR PULSED ELECTROCHEMICAL MACHINING

(71) Applicant: Rolls-Royce Corporation, Indianapolis, IN (US)

(72) Inventor: Rusty M. Garner, Indianapolis, IN (US)

(21) Appl. No.: 17/661,430

(22) Filed: Apr. 29, 2022

(51) Int. Cl. B23H 3/04; B23H 3/06

(52) U.S. Cl. CPC B23H 3/04; B23H 3/06; B23H 2300/10

(57) ABSTRACT

The disclosure describes a method for manufacturing a pulsed electrochemical machining (pECM) tool that includes forming an electrode on a surface of a support substrate. The support substrate includes an electrically non-conductive material. The electrode includes one or more layers of an electrically conductive material and defines a working surface configured to face a workpiece.

### TECHNICAL FIELD

The disclosure relates to pulsed electrochemical machining (pECM).

### BACKGROUND

Machining processes may involve removal of material from a workpiece to form a component having a finished shape and texture. Pulsed electrochemical machining (pECM) is a non-contact machining process based on the principles of electrolysis. Pulsed electrochemical machining may also be referred to as precision electrochemical machining or pulse electrochemical machining. A pECM system may include a tool (the cathode) that imparts its shape into a workpiece (the anode) in a mirror image. As the tool moves toward a surface of the workpiece to be machined, a pulsed DC current may be applied to the tool and the workpiece. The tool maintains a tiny interelectrode gap (e.g., of less than about 10 microns) from the surface of the workpiece, and the workpiece dissolves anodically about the tool, taking on the complementary shape of the tool. An electrolyte pumped between the tool and the workpiece may remove dissolved metal from the workpiece and heat.

Since the cathodic tool does not physically contact the anodic workpiece, pECM can produce burr-free three-dimensional shapes with little or no tool wear. pECM may be used to machine any conductive metal or alloy, and is particularly well suited for materials, such as superalloys, that are difficult to machine through conventional methods. Materials commonly machined with pECM include, for example, nickel, iron, and titanium-based alloys in a variety of formats such as cast (including single crystal), forged, additively manufactured, and powdered metallurgy.

### SUMMARY

The disclosure generally describes systems and techniques for forming pECM electrodes by depositing conductive layers on non-conducting substrates. A pECM tool includes one or more electrodes formed from electrically conductive materials. Each electrode defines a working surface for generating an electric current in an electrolyte between the electrode and a workpiece to remove material from the workpiece. During fabrication of the pECM tool, the electrode is deposited on a deposition surface of a support substrate that is formed from an electrically non-conductive material, such as a ceramic or a polymer. For example, the electrically conductive material of the electrode may be deposited using electroless plating, vapor deposition, additive manufacturing, or another non-electrolytic deposition method. A resulting contour of the working surface of the electrode may reflect a contour of the deposition surface of the support substrate. The electrically non-conductive material of the support substrate may be relatively inexpensive and capable of being formed or machined into a desired shape with high accuracy. For example, the non-conductive material may be formed using three-dimensional (3D) printing. In this way, pECM tools may be formed inexpensively with high working surface accuracy.

In some examples, the disclosure describes a method for manufacturing a pulsed electrochemical machining (pECM) tool that includes forming an electrode on a surface of a support substrate. The support substrate includes an electrically non-conductive material. The electrode includes one or more layers of an electrically conductive material and defines a working surface configured to face a workpiece.

In some examples, the disclosure describes a pulsed electrochemical machining (pECM) tool that includes a tool body defining a tool axis and including a support substrate and an electrode on a deposition surface of the support substrate. The support substrate includes an electrically non-conductive material. The electrode includes one or more layers of an electrically conductive material and defines a working surface configured to face a workpiece. The working surface of the electrode substantially mirrors the deposition surface of the support substrate.

In some examples, the disclosure describes a pulsed electrochemical machining (pECM) system that includes a pECM tool, a mechanical system, an electrolyte system, and a power supply. The pECM tool includes a tool body defining a tool axis and including a support substrate and an electrode on a deposition surface of the support substrate. The support substrate includes an electrically non-conductive material. The electrode includes one or more layers of an electrically conductive material and defines a working surface configured to face a workpiece. The working surface of the electrode substantially mirrors the deposition surface of the support substrate. The mechanical system is configured to position the working surface of the electrode relative to the workpiece. The electrolyte system is configured to supply electrolyte to the mechanical system for delivery to an interelectrode gap between the working surface of the electrode and a target surface of the workpiece. The power supply is configured to generate an electric potential between the electrode of the pECM tool and the workpiece.

In some examples, the disclosure describes a method for pulsed electrochemical machining (pECM) a workpiece that includes generating an electric potential between an electrode of the pECM tool described above and the workpiece. The method further includes delivering an electrolyte into an interelectrode gap between the working surface of the electrode and a target surface of the workpiece. The method further includes positioning the working surface of the electrode relative to the target surface of the workpiece to remove material from the target surface of the workpiece.

The details of one or more examples are set forth in the accompanying drawings and the description below. Other features, objects, and advantages will be apparent from the description and drawings, and from the claims.

### BRIEF DESCRIPTION OF DRAWINGS

FIG. 1A is a conceptual block diagram illustrating a pulsed electrochemical machining (pECM) system.

FIG. 1B is a side view cross-sectional conceptual diagram illustrating operation of a pECM tool of the pECM system of FIG. 1A.

FIG. 1C is a side view cross-sectional conceptual diagram illustrating a magnified view of a portion of FIG. 1B.

FIG. 1D is a conceptual block diagram illustrating an example control system of the pECM system of FIG. 1A.

FIG. 1E is a flow diagram illustrating an example technique for controlling the pECM system of FIG. 1A.

FIG. 2A is a side view cross-sectional conceptual diagram illustrating a pECM tool that includes an electrode formed from an electrically conductive material on an electrically non-conductive support substrate.

FIG. 2B is a side view cross-sectional conceptual diagram illustrating a pECM tool that includes an electrode formed from two different electrically conductive materials on an electrically non-conductive support substrate.

FIG. 3 is a flow diagram illustrating an example process for manufacturing a pECM tool that includes an electrode formed from an electrically conductive material on an electrically non-conductive support substrate.

### DETAILED DESCRIPTION

The disclosure generally describes pECM systems and techniques that include one or more electrodes, which function as one or more cathodes during a pECM process, that are formed on an electrically non-conductive support substrate using a non-electrolytic deposition process. During material removal via the pECM process, a contour and shape of a machined surface of a workpiece (anode) may correspond to a contour and shape of a working surface of the electrode (cathode). Fabrication processes that involve forming the electrode as a bulk material (e.g., via forging) or machining the electrode from a bulk material (e.g., via subtractive manufacturing) may have difficulty controlling the dimensions of the working surface. Additionally, while electrical properties of the electrode near the working surface are important for generating an electrical potential at the working surface, such electrical properties are unnecessary for a bulk of a tool body away from the working surface, adding unnecessary expense. While the electrode may be electroplated on to a less expensive metal substrate, this metal substrate may still be difficult to form or machine to the accuracy required for the working surface of the electrode.

In the present disclosure, a tool body of a pECM tool may include an electrode on an electrically non-conductive support substrate. The support substrate may be formed from an electrically non-conductive material, such as a polymer or ceramic, that is rigid enough to support a thin electrode layer and relatively inexpensive to fabricate into a finished shape of the tool body. Rather than shape the working surface of the electrode into a desired contour, a deposition surface of the support substrate may be formed or machined into a contour corresponding to a desired contour of the working surface of the electrode. One or more layers of an electrically conductive material may be deposited on to the deposition surface of the support substrate using a non-electrolytic deposition process to form the working surface of the electrode, such that the working surface of the electrode substantially mirrors the deposition surface of the support substrate. For example, the non-electrolytic deposition process may include depositing a metal on to the deposition surface using electroless plating or vapor deposition, or depositing an electrically conductive or doped polymer on to the deposition surface using 3D printing. As a result, the pECM tool may have a high accuracy working surface while being relatively inexpensive to fabricate.

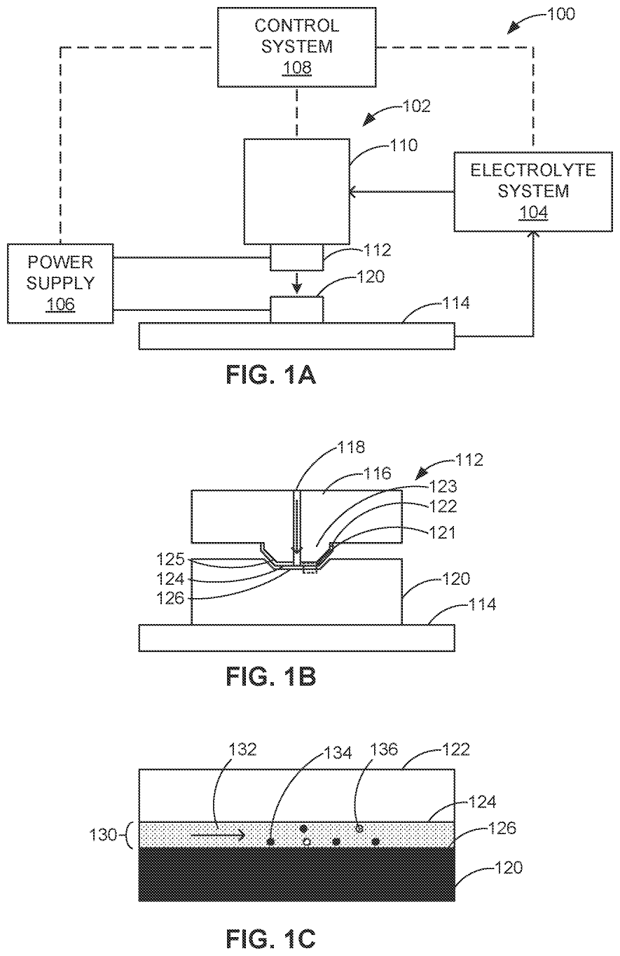

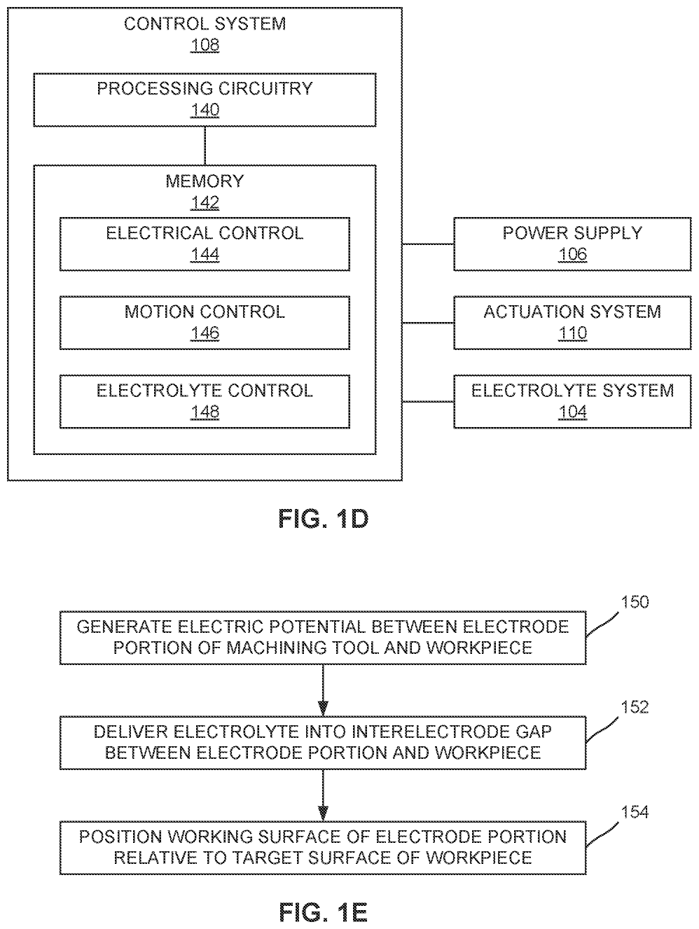

Machining tools described herein may be used as part of a pulsed electrochemical machining (pECM) system. For example, a pECM process may not involve mechanical processes that exert high stresses on a machining tool, such that a pECM tool formed from less mechanically robust materials, such as a thin electrode layer and a non-metallic support substrate, may be particularly suitable for the pECM process. FIG. 1A is a schematic conceptual block diagram illustrating an example pECM system 100 for machining a workpiece 120. pECM system 100 includes a mechanical system 102, an electrolyte system 104, a power supply 106, and a control system 108. While illustrated as separate components, the various components of pECM system 100 may be integrated with other components (e.g., power supply 106 incorporated into mechanical system 102) or overlap with other components (e.g., controllers of mechanical system 102 overlapping with control system 108). While examples of the disclosure are described primarily with regard to pulsed electrochemical machining processes performed by pECM system 100, other examples of the disclosure may be employed using other machining techniques that employ electrochemical machining to shape or otherwise selectively remove material from a workpiece.

Mechanical system 102 may include an actuation system 110, a machining tool 112, and an enclosure system 114. Actuation system 110 may be configured to control a position of machining tool 112 relative to workpiece 120. During a pECM process, actuation system 110 may adjust the position of tool 112 relative to workpiece 120 as needed by moving tool 112, workpiece 120, or both. Actuation system 110 may include one or more actuators, such as direct drive actuators, configured to move tool 112 and/or workpiece 120 as desired during a pECM process. For examples, one or more actuators may be configured to feed or otherwise move machining tool 112 toward workpiece 120 during a pECM process. In some examples, actuation system 110 may be configured to oscillate machining tool 112 (e.g., along the z-axis shown in FIGS. 1B and 1C). Such movement of tool 112 by actuation system may improve removal of dissolved material and restore a concentration of electrolyte between machining tool 112 and workpiece 120. As illustrated in the example of FIG. 1A, mechanical system 102 may be configured to receive electrolyte from electrolyte system 104 and discharge the electrolyte to or proximate to machining tool 112.

Machining tool 112 may be configured to mechanically couple to actuation system 110 and electrically couple to power supply 106. For example, machining tool 112 may include one or more structures or assemblies to couple to actuation system 110, such that machining tool 112 receives a control force for positioning machining tool 112, electrolyte (if distributed via mechanical system 102) for discharging from machining tool 112, and electrical current for generating an electric potential between machining tool 112 and workpiece 120. As will be described further in FIGS. 1B and 1C below, machining tool 112 may be configured to define a working surface that, in combination with workpiece 120 and the electrolyte supplied by electrolyte system 104, forms an electrolytic cell that dissolves material from the outer surface of workpiece 120 using electrolysis.

Enclosure system 114 may be configured to mount workpiece 120 and electrically couple workpiece 120 to power supply 106 for generating a voltage between machining tool 112 and workpiece 120 (e.g., in the form of a pulsed direct current). For example, enclosure system 114 may position workpiece 120 toward machining tool 112, such that a working surface of workpiece 120 is exposed to a working surface of machining tool 112. In some examples, enclosure system 114 may capture spent electrolyte from workpiece 120 for return to electrolyte system 104.

Electrolyte system 104 may be configured to condition and circulate electrolyte (e.g., liquid electrolyte) for distribution to a working surface of machining tool 112, such as via mechanical system 102. Electrolyte system 104 may include one or more pumps configured to discharge the electrolyte to mechanical system 102, one or more filters configured to filter contaminants from the electrolyte (e.g., for the re-use of electrolyte in the pECM process), one or more heat exchangers configured to remove heat from the electrolyte, and/or other components configured to maintain various parameters of the electrolyte.

Power supply 106 may be configured to generate an electric potential between machining tool 112 and workpiece 120. For example, power supply 106 may be configured to apply a voltage between machining tool 112 and workpiece 120 to generate current flow between machining tool 112 and workpiece 120 with the electrolyte flowing or otherwise present between machining tool 112 and workpiece 120. For a pulse EMC process, power supply 106 may be configured to supply voltage in pulses, such as in combination with oscillations of machining tool 112 relative workpiece 120, to increase local current density. For example, power supply 106 may include a direct current (DC) source that applies a pulsed direct current to both machining tool 112 and workpiece 120 during the pulse electrochemical machining process. In some examples, actuation system 110 may oscillate the position of machining tool 112 relative workpiece 120 in coordination with the pulsed direct current.

Control system 108 may be communicatively coupled to mechanical system 102, electrolyte system 104, and power supply 106, and configured to send control signals to mechanical system 102, electrolyte system 104, and power supply 106. For example, the control signals may cause mechanical system 102 to control (e.g., dynamically) a position of machining tool 112 relative to workpiece 120, cause electrolyte system 104 to supply electrolyte between machining tool 112 and workpiece 120, and cause power supply 106 to generate an electric potential between machining tool 112 and workpiece 120. Further operation of control system 108 will be described in FIG. 1D below.

Machining tool 112 defines a working surface that forms workpiece 120 into a component having a particular shape or set of dimensions (e.g., approximately the complimentary shape of machining tool 112). FIG. 1B is a side view cross-sectional conceptual diagram illustrating operation of machining tool 112 of pECM system 100 of FIG. 1A. Machining tool 112 includes a tool body 116 defining a tool axis that aligns with an axis of actuation system 110 of FIG. 1A. Tool body 116 includes one or more electrodes 122 (one or more cathodes). While illustrated in FIG. 1B as including a single electrode 122, tool body 116 may include multiple electrodes 122. While the term electrode is used herein for the machining tool, an electrode generally defines a cathode during a pECM process and may be referred to as such. However, in some cases, a pECM process may include reversing the polarity of a pulse such that the tool electrode functions (e.g., periodically) as the anode with the workpiece being the cathode.

Each electrode 122 defines a working surface 124 at a distal end of the tool axis. When machining tool 112 is attached to actuation system 110, each working surface 124 is configured to face a corresponding target surface 126 of workpiece 120. In some examples, such as illustrated in FIG. 1B, tool body 116 may include an electrolyte channel 118 configured to receive an electrolyte from electrolyte system 104 (e.g., via mechanical system 102) and discharge the electrolyte through one or more openings near working surface 124 of electrode 122.

Each electrode 122 includes an electrically conductive material at working surface 124. An electrically conductive material may include any material having an electrical conductivity greater than about 1×10⁶ S/m. Likewise, workpiece 120 may be an electrically conductive material. When an electric potential (e.g., in the form of a pulse direct current) is generated between working surface 124 of electrode 122 and target surface 126 of workpiece 120 (e.g., with power supply under the control of control system 108), working surface 124 may form a cathode surface and target surface 126 may form an anode surface. As working surface 124 is advanced and material from workpiece 120 is removed, a shape of target surface 126 may generally correspond to the complimentary shape of working surface 124. While the shape of workpiece 120 is shown to mirror the shape of electrode 122 in FIG. 1B, in other examples, the dimensions and shape formed in workpiece 120 from the removal of material from workpiece 120 do not exactly mirror the shape of the tool 112.

The conductive materials of electrode(s) 122 and workpiece 120 may be any suitable conductive material such as metal, metal alloy, or ceramic material. Examples of metals that may be used to form the workpiece 120 and the electrode(s) 122 of tool 112 include nickel, iron, and titanium-based alloys in a variety of formats such as cast (including single crystal), forged, additively manufactured, and powdered metallurgy. Examples of suitable metals and metal alloys for the workpiece 120 and electrode(s) 122 of tool 112 include, but are not limited to, any superalloy such as CMSX-4, MarM247, Haynes 230, Rene N-5, MP35N, and the like, steels such as 4140, A2 tool steel, M4 tool steel, and gear steels such as Ferrium C64, Al 6061, Al 7075, brass, bronze, CoCr, Cu, Ge, Inconels such as 625, 718, and 740h, Mo, Ni, Nitinol, Nitronic 60, Pyrowear 53, stainless steels such as 17-4, 304, 316, and 440C, Ti Grade 1-5, Ti 64, TiAl, and mixtures and combinations thereof.

pECM system 100 may be particularly suited for machining relatively hard superalloys as workpiece 120, including nickel superalloys such as CMSX-4. In some examples, the nickel superalloy may have a composition including Chromium (e.g., about 5.5 wt % to about 7.5 wt %), Cobalt (e.g., about 9 wt % to about 11 wt %), Molybdenum (e.g., about 0.3 wt % to about 0.9 wt %), Tungsten (e.g., about 5 wt % to about 7 wt %) e.g., with the balance being nickel. In some examples, such a nickel superalloy may also include Titanium (e.g., about 0.5 wt % to about 1.5 wt %), Titanium (e.g., about 0.5 wt % to about 1.5 wt %), Hafnium (e.g., about 0 wt % to about 0.2 wt %), Tantalum (e.g., about 5.5 wt % to about 6.5 wt %), Tantalum (e.g., about 5.5 wt % to about 6.5 wt %), Rhenium (e.g., about 2 wt % to about 4 wt %), and/or Rhenium (e.g., about 2 wt % to about 4 wt %) in trace amounts.

Electrode 122 may include a coating on a support substrate 123. For example, electrode 122 may have a thickness between about 10 nanometers and about 1 millimeter. In some examples, an electrically conductive material of at least one layer of electrode(s) 122 may be selected according to an ability to deposit on to an electrically non-conductive material using a non-electrolytic deposition process. As one example, the electrically conductive material may include a metal that is capable of vaporizing and subsequently depositing on to a surface of non-electrically conductive substrate including, but not limited to, tungsten, aluminum, copper, titanium, nickel, chromium, and other metals for which a volatile precursor is available. As another example, the electrically conductive material may include a metal that is capable of chemically depositing on to a surface of a non-electrically conductive substrate via chemical reduction from a metal cation including, but not limited to, nickel (e.g., nickel-phosphorus, nickel-gold, or nickel-boron), copper (e.g., copper-formaldehyde), chromium, and other metals for which a cation salt and autocatalytic agent are available. As another example, the electrically conductive material may include a metal or electrically conductive or doped polymer that is capable of being additively manufactured including, but not limited to, aluminum, poly(3,4-ethylenedioxythiophene):polystyrene sulfonate (PEDOT:PSS), and other materials for which a powder substrate may be deposited and fused.

Support substrate 123 includes an electrically non-conductive material. An electrically non-conductive material may include any material having an electrical conductivity less than about 1×10⁶ S/m. Support substrate 123 may be configured to support electrode 122 during a pECM process, such as by maintaining dimensional stability and resisting deformation in response to pulsed movement and electrolyte flow. Correspondingly, the electrically non-conductive material of support substrate 123 may be substantially strong and rigid to provide support for electrode 122 under pECM processing conditions, and/or may be relatively inexpensive compared to the electrically conductive material of electrode 122 or other electrically conductive materials. The electrically non-conductive material of support substrate 123 may also be capable of being formed into shapes having a high degree of dimensional accuracy, dimensional stability, and manufacturability using additive or subtractive manufacturing processes. For example, the electrically non-conductive material may be capable of being formed by additive manufacturing processes, such as fused filament fabrication, or subtractive manufacturing, such as abrasion. A variety of electrically non-conductive materials may be used including, but not limited to, structural polymers, such as thermoplastics and thermosets; ceramics; and the like. Thermoplastics that may be used include, but are not limited to, polystyrene, polyethylene, acrylonitrile-butadiene styrene (ABS), polyvinyl, polypropylene, polyester, polycarbonate, nylon, polyacetal, poly(phenylene oxide), and the like.

Due to the relatively easy fabrication and/or high degree of accuracy of a contour and shape of support substrate 123, at least one surface of support substrate 123 may be formed to reflect a desired contour and shape of working surface 124 of electrode 122. For example, electrode 122 may have a relatively uniform thickness (e.g., due to a relatively thin layer of electrically conductive material), such that the contour of working surface 124 may mirror (e.g., be substantially similar to) the contour of the surface of support substrate 123. As a result, rather than forming working surface 124 into a desired contour through a contour-controlled process, support substrate 123 may be formed into the desired contour and shape, and electrode 122 may be deposited on the surface of support substrate 123 in a thickness-, rather than contour-, controlled process. In some examples, working surface 124 may have a relatively complex contour, which may be difficult to form using bulk forming or subtractive manufacturing processes, and expensive to form using additive manufacturing processes. In contrast, forming the electrode from a deposition process that controls a thickness, rather than a contour or shape, of deposition layers may shift a contour-controlling process to a more easily formed or machined electrically non-conductive material of the support substrate 123. As a result, machining tool 112 may be formed relatively inexpensively while including an electrode with an accurate working surface.

Relatively inexpensive fabrication of machining tool 112 may enable machining tool 112 to be disposable. For example, a machining tool 112 fabricated from an inexpensive polymer and only a small amount of metal for electrode 122 may be used for a limited lifespan and disposed of, rather than redressed. In such examples, such inexpensive substrates 123 may be fabricated using low cost mass manufacturing methods, such as forging or extrusion. Conversely, a relatively thin layer of conductive material as electrode 122 may permit simpler redressing of electrode 122. For example, the conductive material of electrode 122 may undergo degradation processes, such as due to arcing. Rather than machine electrode 122 through a subtractive machining process that may be difficult to control, electrode 122 may be stripped to the underlying substrate 123 and re-coated to a relatively even coating, thereby renewing working surface 124.

FIG. 1C is a side view cross-sectional conceptual diagram showing a magnified view within window 121 indicated in FIG. 1B to illustrate operating principles of the pECM tool of FIG. 1B. Working surface 124 of electrode 122 is positioned relative to target surface 126 of workpiece 120 to form an interelectrode gap 130, and an electrolyte 132 flows through interelectrode gap 130. When an electric potential (e.g., in the form of a pulse direct current) is generated between working surface 124 and target surface 126, current flows from working surface 124 to target surface 126 via electrolyte 132 to form an electrolytic cell. The current dissolves material at target surface 126 to generate electrochemical reaction products that include dissolved material 134, hydrogen gas 136, and heat. Electrolyte 132 carries away the electrochemical reaction products from interelectrode gap 130. In general, material removal rate may be related to current density in interelectrode gap 130. The current density in interelectrode gap 130 may be related to a variety of parameters including, but not limited to: spatial parameters, such as a distance of interelectrode gap 130; electrical parameters, such as an electric potential across interelectrode gap 130; electrolyte parameters, such as a flow rate of electrolyte 132; and other parameters that may affect flow of current from working surface 124 to target surface 126.

FIG. 1D is a conceptual block diagram illustrating an example control system 108 of pECM system 100 of FIG. 1A. Control system 108 includes processing circuitry 140 and a memory 142. Memory 142 includes computer-readable instructions that, when executed by processing circuitry 140, causes processing circuitry 140 to perform various functions related to control of components of pECM system 100. Processing circuitry 140 may include any one or more microprocessors, controllers, digital signal processors (DSPs), application specific integrated circuits (ASICs), field-programmable gate arrays (FPGAs), or equivalent discrete or integrated digital or analog logic circuitry, and the functions attributed to processing circuitry 140 herein may be embodied as software, firmware, hardware or any combination thereof. Memory 142 may include any volatile, non-volatile, magnetic, optical, or electrical media, such as a random access memory (RAM), read-only memory (ROM), non-volatile RAM (NVRAM), electrically-erasable programmable ROM (EEPROM), flash memory, or any other digital media.

Memory 142 may store any suitable information, including information for executing one or more electrochemical machining processes with which pECM system 100 performs on workpiece 120. For example, memory 142 may store one or more of electrical control instructions 144, motion control instructions 146, and electrolyte control instruction 148 in separate memories within memory 142 or separate areas within memory 142. Electrical control 144, motion control 146, and electrolyte control 148 may, in combination, define parameters that control pECM system 100 to remove material from workpiece 120 to generate a component having particular dimensions. In some examples, workpiece 120 may be a partially fabricated component having relatively rough dimensions, such that the pECM process may further refine workpiece 120 to relatively fine dimensions.

Electrical control 144 may define values for electrical parameters of a pECM process including, but not limited to, voltage amplitude applied to electrode 122 and workpiece 120, frequency of electric current, duty cycle (e.g., pulse length), current amplitude, and other electric parameters associated with control of current across interelectrode gap 130. Processing circuitry 140 may generate and send control signals that include the electrical parameters to electrical control circuitry of power supply 106.

Motion control 146 may define values for motion parameters of a pECM process including, but not limited to, feed rate of machining tool 112, position of machining tool 112 (e.g., depth limit of machining tool 112), frequency of oscillation of machining tool 112, amplitude of oscillation of machining tool 112, length of interelectrode gap 130, and other motion parameters associated with control of relative and/or time-varying position of working surface 124. Processing circuitry 140 may generate and send control signals that include the motion parameters to actuation circuitry of actuation system 110.

Electrolyte control 148 may define values for electrolyte parameters of a pECM process including, but not limited to, flow rate of electrolyte 132 through interelectrode gap 130, temperature of electrolyte 132, and other electrolyte parameters associated with conditions of electrolyte 132 in interelectrode gap 130. Processing circuitry 140 may generate and send control signals that include the electrolyte parameters to electrolyte control circuitry of electrolyte system 104.

FIG. 1E is a flow diagram illustrating an example technique for controlling pECM system 100 of FIG. 1A. While illustrated sequentially, the various steps of FIG. 1E may be initiated in a different order (or sequentially) to remove material from workpiece 120. Control system 108 may cause power supply 106 to generate an electric potential between electrode 122 and workpiece 120 (150) and cause electrolyte system 104 to deliver electrolyte 132 into interelectrode gap 130 between working surface 124 of electrode 122 and target surface 126 of workpiece 120 (152) to form an electrolytic cell. Control system 108 may cause actuation system 110 to position working surface 124 of electrode 122 relative to target surface 126 of workpiece 120 (154) to control the size of interelectrode gap 130 and advance working surface 124 toward target surface 126 as material is removed from workpiece 120. In some examples, interelectrode gap 130 may be on the order of about 10 microns although other values are contemplated.

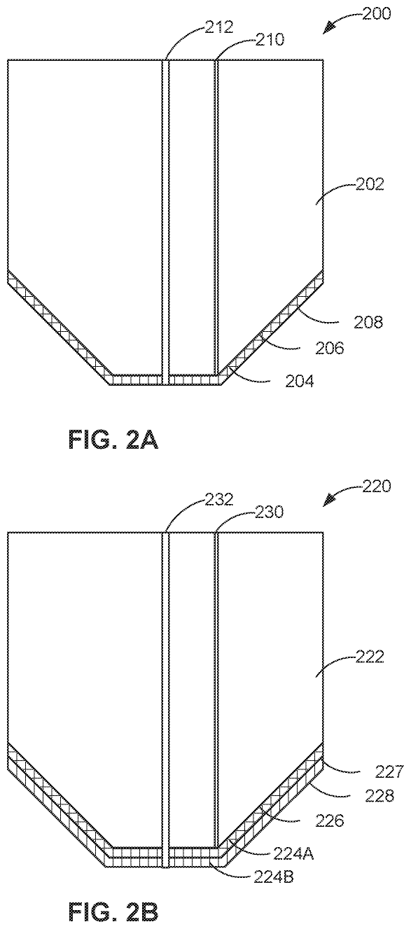

FIG. 2A is a side view cross-sectional conceptual diagram illustrating a pECM tool 200 that includes an electrode formed from an electrically conductive material on an electrically non-conductive support substrate. pECM tool 200 includes an electrode 204, a support substrate 202, and an electrolyte channel 212. Unless otherwise stated, electrode 204, support substrate 202, and electrolyte channel 212 may be similar to electrode 122, support substrate 123, and electrolyte channel 118 of FIGS. 1A-1E.

Support substrate 202 defines a deposition surface 206. Deposition surface 206 may include one or more outer surfaces of support substrate 202 configured to receive electrode 204. In the example of FIG. 2A, deposition surface 206 is positioned at a distal end of pECM tool 200; however, in other examples, deposition surface 206 may be at other portions of pECM tool 200, such as along lateral side of pECM tool. At least a portion of deposition surface 206 may have a desired surface contour of working surface 208. Electrically conductive materials, such as metals, may be difficult and/or expensive to accurately form into the desired surface contour of a working surface of an electrode, such as by using bulk forming or subtractive manufacturing processes. In contrast, electrically non-conductive materials, such as thermoplastics, have a wider range of mechanical properties and price points, such that the electrically non-conductive materials may be substantially easier and/or less expensive to shape into the desired surface contours using additive or subtractive manufacturing processes. In some examples, deposition surface 206 may have a relatively complex contour. In the example of FIG. 2A, deposition surface 206 has a modified conical shape in multiple planes. However, in other examples, deposition surface 206 may included straight, curved, overhung, or other surface contours or combinations of surface contours.

Electrode 204 is positioned on deposition surface 206 of support substrate 202. Electrode 204 includes one or more layers of an electrically conductive material and defines a working surface 208 configured to face a workpiece. Working surface 208 may have a surface contour that substantially matches a surface contour of deposition surface 206 of support substrate 202. For example, electrode 204 may be sufficiently thin and uniform that the contour of working surface 208 may match the contour of deposition surface 206. The one or more layers of electrode 204 may have a sufficient high thickness to resist deformation, in combination with support substrate 202, of electrolyte pressure against electrode 204 and/or a sufficiently low thickness such that a contour of working surface 208 substantially reflects a contour of deposition surface 206. In some examples, the one or more layers of electrode 204 may have a total thickness of between about 100 nm and about 1 mm. Electrode 204 may have a substantially uniform thickness, such as a thickness having less than about 10 nm variation or 10% variation of a total thickness of electrode 204.

pECM tool 200 includes an electrical conductor 210 configured to electrically couple electrode 204 to a power supply, such as power supply 106 of FIG. 1A. Electrical conductor 210 may include any electrically conductive material, and while illustrated as a single electrical conductor 210, may include any number of electrical conductors. In the example of FIG. 2A, electrical conductor 210 is positioned within support substrate 202. For example, the electrically non-conductive material of support substrate 202 may be relatively easy to machine, such that electrical conductor 210 may be positioned within a cavity extending to electrode 204. However, in other examples, electrical conductor 210 may be positioned on an outer surface of support substrate 202, such as extending down a side of support substrate 202.

In some examples, electrodes may include more than one layer of an electrically conductive material. For example, a first electrically conductive layer deposited by a non-electrolytic deposition process may form a base material for further electrolytic deposition processes of other electrically conductive materials. FIG. 2B is a side view cross-sectional conceptual diagram illustrating a pECM tool 220 that includes an electrode formed from two different electrically conductive materials on an electrically non-conductive support substrate. pECM tool 200 includes an electrode 224, a support substrate 222, an electrolyte channel 232, and an electrical conductor 230. Unless otherwise stated, electrode 224, support substrate 222, electrolyte channel 232, and electrical conductor 230 may be similar to electrode 204, support substrate 202, electrolyte channel 212, and electrical conductor 210 of FIG. 2A.

In the example of FIG. 2B, electrode 224 includes a first portion 224A that includes one or more layers of a first electrically conductive material on a deposition surface 226 of support substrate 222. The first electrically conductive material may be particularly suited to non-electrolytic deposition processes such as vapor deposition, electroless plating, or additive manufacturing. Electrode 224 may further includes a second portion 224B that includes one or more layers of a second electrically conductive material on a surface of the one or more layers of the first electrically conductive material. The second electrically conductive material may be particularly suited for generating an electrical potential from electrode 224. For example, the second electrically conductive material may not be as easily formed using non-electrolytic deposition processes. However, the presence of the first electrically conductive material as first portion 224A may enable electrolytic deposition processes, such as electroplating, that may be more suitable for depositing the second electrically conductive material.

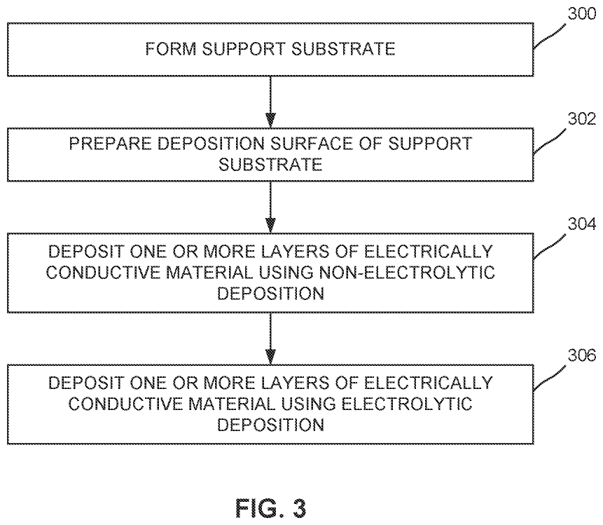

FIG. 3 is a flow diagram illustrating an example process for manufacturing a pECM tool that includes an electrode formed from an electrically conductive material on an electrically non-conductive support substrate. The method of FIG. 3 will be described with respect to pECM tools 200 and 220 of FIGS. 2A and 2B; however, the method of FIG. 3 may be used to form other pECM tools, and may include additional or fewer steps than that shown.

The method of FIG. 3 may include forming support substrate 202 from an electrically non-conductive material (300). Forming support substrate 202 may include defining a shape of support substrate 202, including a contour of deposition surface 206, as well as any cavities within or on support substrate 202, such as electrolyte channel 212 and a channel for electrical conductor 210. A variety of processes may be used to form support substrate 202 including, but not limited to, additive manufacturing processes, such as fused filament fabrication; subtractive manufacturing processes, such as abrasion; forming processes, such as extrusion; and any combination thereof. For example, support substrate 202 may be formed by additive manufacturing into a general shape, and one or more surfaces of support substrate, such as deposition surface 206, may be further refined using a high precision subtractive manufacturing process.

In some examples, support substrate 202 may be formed from an additive manufacturing process. For example, a computing device or other processing circuitry may receive a three-dimensional representation of a desired shape and/or contour of a target surface of a workpiece or, if known, a shape and/or contour of working surface 208 of electrode 204. The computing device may generate instructions for an additive manufacturing system, such as a 3D printing system, to fabricate support substrate 202 with a contour of deposition surface 206 corresponding to a contour of the target surface of the workpiece or working surface 208 of electrode 204. The instructions may account for a thickness of electrode 204 or, if electrode 204 is configured to be sufficiently thin, may not account for the thickness of electrode 204. The computing device may output the instructions to the 3D printing system to cause the 3D printing system to form support substrate 202 according to the instructions. Additional cavities of support substrate 202 may be incorporated into the instructions, or may be formed through subtractive manufacturing (e.g., drill press) after fabrication of an outer form of support substrate 202. In this way, substrate 202 may be formed relatively inexpensively compared to metallic substrates.

The method of FIG. 3 may include preparing a deposition surface of support substrate 202 (302). Preparation processes may include cleaning one or more surfaces of support substrate 202, including deposition surface 206, and/or may include pretreating deposition surface 206 to increase adhesion and/or deposition of an electrically conductive material on deposition surface 206. For example, deposition surface 206 may be electrostatically charged, may be functionalized (e.g., with hydrophilic groups), may be coated with an additional layer (e.g., an autocatalytic material or adhesive material), or any other pretreatment that aid in adhesion or deposition of the electrically conductive material.

The method of FIG. 3 may include forming electrode 204 on a surface of support substrate 202. Forming electrode 204 may include depositing one or more layers of an electrically conductive material on deposition surface of support substrate 123 using a non-electrolytic deposition process (304). A variety of non-electrolytic processes may be used including, but not limited to, vapor deposition, such as chemical or physical vapor deposition; liquid deposition, such as electroless plating; additive manufacturing, such as 3D printing; and any other process that does not rely on coating a cathode through reduction of cations using an electric current.

In some examples, depositing the one or more layers of the electrically conductive material includes vapor deposition. For example, a vapor metal precursor, such as a metal compound or metal ion, may be received or formed, such as through evaporation or sputtering, or other vaporization process. The vapor metal precursor may be deposited on to deposition surface 206 of support substrate 202, such as by reacting with deposition surface 206 or another material on deposition surface 206 or decomposing on to deposition surface 206. The vapor deposition process may be continued until one or more layers of the electrically conductive material forms a desired thickness.

In some examples, depositing the one or more layers of the electrically conductive material includes electroless plating. For example, deposition surface 206 of support substrate 202 may be immersed in a liquid bath that includes a liquid metal precursor, such as a dissolved metal cation or suspended metal particles, a reducing agent, and, if the metal precursor is not autocatalytic, a catalyst either in solution or on deposition surface 206. The liquid metal precursor may be deposited on to deposition surface 206, resulting in a metal alloy. The electroless plating process may be continued until one or more layers of the electrically conductive material forms a desired thickness.

In some examples, depositing the one or more layers of the electrically conductive material includes additive manufacturing. For example, a metal or polymer precursor, such as a metal powder or polymer filament, may be fed toward an energy source configured to melt or fuse the metal or polymer precursors together. The additive deposition process may be continued until one or more layers of the electrically conductive material forms a desired thickness.

In some examples, forming electrode 224 may include depositing one or more additional layers of an electrically conductive material on one or more layers of an existing electrically conductive material using an electrolytic deposition process (306), such as illustrated in FIG. 2B. For example, one or more layers of a first electrically conductive material may be deposited on deposition surface of support substrate using a non-electrolytic deposition process, such as vapor deposition or electroless plating. These electrically conductive layers may provide a platform for depositing one or more layers of a second electrically conductive material on the surface of the one or more layers of the first electrically conductive material using an electrolytic deposition process, such as electroplating.

Example 1: A method for manufacturing a pulsed electrochemical machining (pECM) tool includes forming an electrode on a deposition surface of a support substrate, wherein the support substrate comprises an electrically non-conductive material, and wherein the electrode comprises one or more layers of an electrically conductive material and defines a working surface configured to face a workpiece.

Example 2: The method of example 1, further comprising forming the support substrate using additive manufacturing.

Example 3: The method of any of examples 1 and 2, wherein the electrically non-conductive material comprises at least one of a ceramic or a polymer.

Example 4: The method of any of examples 1 through 3, wherein forming the electrode further comprises depositing the one or more layers of the electrically conductive material on the deposition surface of the support substrate.

Example 5: The method of example 4, wherein the electrically conductive material comprises a metal.

Example 6: The method of example 5, wherein the metal comprises at least one of aluminum, copper, nickel, or chromium.

Example 7: The method of any of examples 5 and 6, wherein depositing the one or more layers of the electrically conductive material comprises vapor deposition.

Example 8: The method of any of examples 5 through 7, wherein depositing the one or more layers of the electrically conductive material comprises electroless plating.

Example 9: The method of any of examples 5 through 8, wherein depositing the one or more layers of the electrically conductive material comprises: depositing one or more layers of a first electrically conductive material on the deposition surface of the support substrate using at least one of vapor deposition or electroless plating; and depositing one or more layers of a second electrically conductive material on a surface of the one or more layers of the first electrically conductive material using electroplating.

Example 10: The method of any of examples 4 through 9, wherein the electrically conductive material comprises at least one of an electrically conductive polymer or a doped polymer.

Example 11: The method of example 10, wherein the one or more layers are deposited using additive manufacturing.

Example 12: The method of any of examples 1 through 11, wherein the electrically conductive material has an electrical conductivity greater than about 1×106 S/m.

Example 13: The method of any of examples 1 through 12, wherein the electrically non-conductive material has an electrical conductivity less than about 1×106 S/m.

Example 14: The method of any of examples 1 through 13, wherein the tool body further comprises one or more electrical conductors configured to electrically couple the electrode to a power supply.

Example 15: The method of any of examples 1 through 14, wherein the one or more layers have a thickness of between about 10 nm and about 1 mm.

Example 16: The method of any of examples 1 through 15, wherein the electrode comprises a first electrode, and wherein the method further comprises forming a second electrode from an electrically conductive material.

Example 17: A pulsed electrochemical machining (pECM) tool includes a tool body defining a tool axis, the tool body includes a support substrate, wherein the support substrate comprises an electrically non-conductive material; and an electrode on a deposition surface of the support substrate, wherein the electrode comprises one or more layers of an electrically conductive material and defines a working surface configured to face a workpiece, and wherein the working surface of the electrode substantially mirrors the deposition surface of the support substrate.

Example 18: The pECM tool of example 17, wherein the electrically non-conductive material comprises at least one of a ceramic or a polymer.

Example 19: The pECM tool of any of examples 17 and 18, wherein the electrically conductive material comprises a metal.

Example 20: The pECM tool of example 19, wherein the metal comprises at least one of aluminum, copper, nickel, or chromium.

Example 21: The pECM tool of any of examples 19 and 20, wherein the one or more layers of the electrically conductive material comprise: one or more layers of a first electrically conductive material on the deposition surface of the support substrate; and one or more layers of a second electrically conductive material on a surface of the one or more layers of the first electrically conductive material.

Example 22: The pECM tool of any of examples 17 through 21, wherein the electrically conductive material comprises at least one of an electrically conductive polymer or a doped polymer.

Example 23: The pECM tool of any of examples 17 through 22, wherein the electrically conductive material has an electrical conductivity greater than about 1×106 S/m.

Example 24: The pECM tool of any of examples 17 through 23, wherein the electrically non-conductive material has an electrical conductivity less than about 1×106 S/m.

Example 25: The pECM tool of any of examples 17 through 24, wherein the tool body further comprises one or more electrical conductors configured to electrically couple the electrode to a power supply.

Example 26: The pECM tool of any of examples 17 through 25, wherein the one or more layers have a thickness of between about 10 nm and about 1 mm.

Example 27: The pECM tool of any of examples 17 through 26, wherein the electrode comprises a first electrode, and wherein the tool body further comprises a second electrode.

Example 28: A pulsed electrochemical machining (pECM) system includes a pECM tool includes a support substrate, wherein the support substrate comprises an electrically non-conductive material; and an electrode on a deposition surface of the support substrate, wherein the electrode comprises one or more layers of an electrically conductive material and defines a working surface configured to face a workpiece, and wherein the working surface of the electrode substantially mirrors the deposition surface of the support substrate; a mechanical system configured to position the working surface of the electrode relative to the workpiece; an electrolyte system configured to supply electrolyte to the mechanical system for delivery to an interelectrode gap between the working surface of the electrode and a target surface of the workpiece; and a power supply configured to generate an electric potential between the electrode of the pECM tool and the workpiece.

Example 29: The pECM system of example 28, wherein the electrically non-conductive material comprises at least one of a ceramic or a polymer.

Example 30: The pECM system of any of examples 28 and 29, wherein the electrically conductive material comprises a metal.

Example 31: The pECM system of example 30, wherein the metal comprises at least one of aluminum, copper, nickel, or chromium.

Example 32: The pECM system of any of examples 28 through 31, wherein the electrically conductive material comprises at least one of an electrically conductive polymer or a doped polymer.

Example 33: The pECM system of any of examples 28 through 32, wherein the electrically conductive material has an electrical conductivity greater than about 1×106 S/m.

Example 34: The pECM system of any of examples 28 through 33, wherein the electrically non-conductive material has an electrical conductivity less than about 1×106 S/m.

Example 35: The pECM system of any of examples 28 through 34, wherein the tool body further comprises one or more electrical conductors configured to electrically couple the electrode to a power supply.

Example 36: The pECM system of any of examples 28 through 35, wherein the one or more layers have a thickness of between about 10 nm and about 1 mm.

Example 37: The pECM system of any of examples 28 through 36, wherein the electrode comprises a first electrode, and wherein the tool body further comprises a second electrode.

Example 38: A method for pulsed electrochemical machining (pECM) a workpiece includes generating an electric potential between an electrode of the pECM tool of any of claims 17 to 27 and the workpiece; delivering an electrolyte into an interelectrode gap between the working surface of the electrode and a target surface of the workpiece; and positioning the working surface of the electrode relative to the target surface of the workpiece to remove material from the target surface of the workpiece.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples have been described. These and other examples are within the scope of the following claims.

1. A method for manufacturing a pulsed electrochemical machining (pECM) tool, comprising:
forming an electrode on a deposition surface of a support substrate,
wherein the support substrate comprises an electrically non-conductive material, and
wherein the electrode comprises one or more layers of an electrically conductive material and defines a working surface configured to face a workpiece.

2. The method of claim 1, further comprising forming the support substrate using additive manufacturing.

3. The method of claim 1, wherein the electrically non-conductive material comprises at least one of a ceramic or a polymer.

4. The method of claim 1, wherein forming the electrode further comprises depositing the one or more layers of the electrically conductive material on the deposition surface of the support substrate.

5. The method of claim 4,
wherein the electrically conductive material comprises a metal, and
wherein the metal comprises at least one of aluminum, copper, nickel, or chromium.

6. The method of claim 5, wherein depositing the one or more layers of the electrically conductive material comprises at least one of vapor deposition or electroless plating.

7. The method of claim 5, wherein depositing the one or more layers of the electrically conductive material comprises:
depositing one or more layers of a first electrically conductive material on the deposition surface of the support substrate using at least one of vapor deposition or electroless plating; and
depositing one or more layers of a second electrically conductive material on a surface of the one or more layers of the first electrically conductive material using electroplating.

8. The method of claim 4,
wherein the electrically conductive material comprises at least one of an electrically conductive polymer or a doped polymer, and
wherein the one or more layers are deposited using additive manufacturing.

9. The method of claim 1,
wherein the electrically conductive material has an electrical conductivity greater than about 1×10⁶ S/m, and
wherein the electrically non-conductive material has an electrical conductivity less than about 1×10⁶ S/m.

10. A pulsed electrochemical machining (pECM) tool, comprising:
a tool body defining a tool axis, the tool body comprising:
a support substrate, wherein the support substrate comprises an electrically non-conductive material; and
an electrode on a deposition surface of the support substrate, wherein the electrode comprises one or more layers of an electrically conductive material and defines a working surface configured to face a workpiece, and wherein the working surface of the electrode substantially mirrors the deposition surface of the support substrate.

11. The pECM tool of claim 10, wherein the electrically non-conductive material comprises at least one of a ceramic or a polymer.

12. The pECM tool of claim 10, wherein the electrically conductive material comprises a metal.

13. The pECM tool of claim 12, wherein the metal comprises at least one of aluminum, copper, nickel, or chromium.

14. The pECM tool of claim 12, wherein the one or more layers of the electrically conductive material comprise:
one or more layers of a first electrically conductive material on the deposition surface of the support substrate; and
one or more layers of a second electrically conductive material on a surface of the one or more layers of the first electrically conductive material.

15. The pECM tool of claim 10, wherein the electrically conductive material comprises at least one of an electrically conductive polymer or a doped polymer.

16. The pECM tool of claim 10,
wherein the electrically conductive material has an electrical conductivity greater than about 1×10⁶ S/m, and
wherein the electrically non-conductive material has an electrical conductivity less than about 1×10⁶ S/m.

17. The pECM tool of claim 10, wherein the tool body further comprises one or more electrical conductors configured to electrically couple the electrode to a power supply.

18. The pECM tool of claim 10, wherein the one or more layers have a thickness of between about 10 nm and about 1 mm.

19. The pECM tool of claim 10,
wherein the electrode comprises a first electrode, and
wherein the tool body further comprises a second electrode.

20. A pulsed electrochemical machining (pECM) system, comprising:
a pECM tool comprising a tool body defining a tool axis, the tool body comprising:
a support substrate, wherein the support substrate comprises an electrically non-conductive material; and
an electrode on a deposition surface of the support substrate, wherein the electrode comprises one or more layers of an electrically conductive material and defines a working surface configured to face a workpiece, and wherein the working surface of the electrode substantially mirrors the deposition surface of the support substrate;
a mechanical system configured to position the working surface of the electrode relative to the workpiece;
an electrolyte system configured to supply electrolyte to the mechanical system for delivery to an interelectrode gap between the working surface of the electrode and a target surface of the workpiece; and
a power supply configured to generate an electric potential between the electrode of the pECM tool and the workpiece.
